(19) United States
(12) Patent Application Publication
(10) Pub. No.: US 2025/0355970 A1
(43) Pub. Date: Nov. 20, 2025

(54) FALL-THROUGH SLOTS FOR DETERMINISTIC FINITE AUTOMATONS IN A REGULAR EXPRESSION ACCELERATOR

(71) Applicant: Microsoft Technology Licensing, LLC, Redmond, WA (US)

(72) Inventors: Edward Leo WIMMERS, San Jose, CA (US); Ashwin Srinath SUBRAMANIAN, San Jose, CA (US); Eric Scot SWARTZENDRUBER, Austin, TX (US); Eric Ronald WEISMAN, Sunnyvale, CA (US); Renat IDRISOV, Menlo Park, CA (US)

(21) Appl. No.: 18/667,056

(22) Filed: May 17, 2024

(51) Int. Cl. G06F 18/22

(52) U.S. Cl. CPC G06F 18/22

(57) ABSTRACT

Systems and methods for implementing fall-through slots for deterministic finite automatons (DFAs) in a regular expression (regex) accelerator are provided. A method includes compiling a set of regular expression patterns to generate an output file, wherein the output file comprises information related to a deterministic finite automaton (DFA) graph, including fall-through information indicative of whether a transition associated with any nodes of the DFA graph comprises a fall-through transition. The method further includes during processing of a payload, executing transitions associated with the DFA graph, including any fall-through transitions.

### BACKGROUND

Regular expressions are used for matching input strings with patterns, each of which can be a word, a phrase, or any set of characters, including symbols. A regular expression can also include metadata and characters that provide rules for searching an input string for a match to a regular expression. Regular expression compilers can be used to generate a binary output that encodes the rules for processing input strings in terms of finite state machine graphs. The graphs and related binaries output by the regular expression compiler can be processed by regular expression engines. The regular expression engines for processing regular expressions can include both deterministic finite automatons (DFAs) and non-deterministic finite automatons (NFAs). While DFAs are used to process single path regular expressions, the NFAs can be used to process instructions that can handle forward matching, reverse matching, looping, or other types of paths. Because of the limited transitions from one state to another, DFAs offer relatively fast search for patterns as defined by regular expressions. However, the size of a DFA graph can grow exponentially based on the nature of the input patterns, including even for simple straight-forward patterns.

Accordingly, there is a need for improvements to the DFA implementations to alleviate such issues.

### SUMMARY

In one example, the present disclosure relates to a method comprising compiling a set of regular expression patterns to generate an output file, wherein the output file comprises information related to a deterministic finite automaton (DFA) graph, including fall-through information indicative of whether a transition associated with any nodes of the DFA graph comprises a fall-through transition. The method may further, include during processing of a payload, executing transitions associated with the DFA graph, including any fall-through transitions.

In another example, the present disclosure relates to a method comprising loading an object file into a memory associated with a regular expression (regex) accelerator, wherein the object file includes information related to a deterministic finite automaton (DFA) graph and fall-through information indicative of whether a transition associated with any nodes of the DFA graph comprises a fall-through transition.

The method may further include the regex accelerator receiving a payload for processing. The method may further include, during processing of the payload, based on the fall-through information, executing transitions associated with the DFA graph without consuming a portion of the payload.

In yet another example, the present disclosure relates to a method comprising loading an object file into a memory associated with a regular expression (regex) accelerator, wherein the object file includes information related to a deterministic finite automaton (DFA) graph and fall-through information indicative of whether a transition associated with any nodes of the DFA graph comprises a fall-through transition. The method may further include receiving a payload from a service external to the regex accelerator.

The method may further include during processing of the payload, based on the fall-through information, executing transitions associated with the DFA graph without consuming a portion of the payload. The method may further include, upon a successful match between the payload and at least one of the set of regular expression patterns, indicating a match.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 is a block diagram of a system environment for implementing fall-through slots for deterministic finite automatons (DFAs) in a regular expression accelerator in accordance with one example;

FIG. 2 is a block diagram of a system for implementing fall-through slots for DFAs in a regex accelerator in accordance with one example;

FIG. 3 shows an example layout of an object file for implementing fall-through slots for DFAs in accordance with one example;

FIG. 4 shows a logical block diagram of a regex accelerator for implementing fall-through slots for DFAs in accordance with one example;

FIG. 5 shows a simplified version of a DFA graph without fall-through slots;

FIG. 6 shows a simplified version of a DFA graph with fall-through slots;

FIG. 7 shows a comparison between a full version of the DFA graph of FIG. 5 without fall-through slots and a full version of the DFA graph of FIG. 6 with fall-through slots;

FIG. 8 is a block diagram of a storage appliance use case for a regex accelerator with fall-through slots;

FIG. 9 is a block diagram of a network appliance use case for a regex accelerator with fall-through slots;

FIG. 10 is a flow chart of a method for implementing fall-through slots for deterministic finite automatons (DFAs) in a regular expression accelerator in accordance with one example; and

FIG. 11 is a flow chart of another method for implementing fall-through slots for deterministic finite automatons (DFAs) in a regular expression accelerator in accordance with one example.

### DETAILED DESCRIPTION

Examples disclosed in the present disclosure relate to methods and systems for implementing fall-through slots for deterministic finite automatons (DFAs) in a regular expression (regex) accelerator. As noted earlier, regular expressions are used for matching input strings with patterns, each of which can be a word, a phrase, or any set of characters, including symbols. A regular expression can also include metadata and characters that provide rules for searching an input string for a match to a regular expression. Regular expression compilers can be used to generate a binary output that encodes the rules for processing input strings in terms of finite state machine graphs. The graphs and related binaries output by the regular expression compiler can be processed by regular expression engines. The regular expression engines for processing regular expressions can include both deterministic finite automatons (DFAs) and non-deterministic finite automatons (NFAs). While DFAs are used to process single path regular expressions, the NFAs can be used to process instructions that can handle forward matching, reverse matching, looping, or other types of paths.

Broadly speaking, a regular expression (regex) compiler converts the input regular expressions into a DFA pre-filter graph and an NFA post-processing instruction sequence, which then run on the corresponding DFA hardware/software and NFA hardware/software. The DFA works by reading a stream of the input payload bytes and traversing the DFA graph based on the value of the payload byte. To improve performance, the DFA graph can be stored in a limited capacity on-chip memory cache. In general, DFAs consume one input payload byte and traverse one edge along the graph. The implementation of the “fall-through” slot, as described herein, allows the DFA to traverse an edge in the graph without consuming the payload byte. For certain workloads, this allows the compiler to produce a compact graph representations for the DFA pre-filters, which improves the hit-rate in the on-chip memory cache and ultimately improves the performance of the regular expression accelerator.

The input strings being searched by a regular expression accelerator can include strings related to networking traffic, intrusion detection (or other security-related data), storage data, or other types of data and/or instructions. As an example, networking traffic can be searched for input strings that may help a security system (e.g., a firewall) deny or permit actions. Similarly, storage data can be searched for input strings to detect any malicious code or data. Hardware accelerators can be used to perform such specialized tasks, which can process the work offloaded by the central processing units (CPUs) or the graphics processing units (GPUs). The specialized tasks can relate to the searching for certain input strings (also referred to as payload) in the context of any of networking, storage, security, or virtualization aspects.

One class of hardware accelerators for processing regular expressions can include deterministic finite automatons (DFAs) and non-deterministic finite automatons (NFAs). A hardware accelerator including such DFAs and NFAs may be implemented using any of Application Specific Integrated Circuits (ASICs), Field Programmable Gate Arrays (FPGAs), Erasable and/or Complex programmable logic devices (PLDs), Programmable Array Logic (PAL) devices, or Generic Array Logic (GAL) devices. Desired regular expression processing functionality can be implemented to support any service that can be offered via a combination of computing, networking, and storage resources, such as via a data center or other infrastructure for delivering a service.

The regex accelerators can also be implemented in cloud computing environments. Cloud computing may refer to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly. A cloud computing model can be composed of various characteristics such as, for example, on-demand self-service, broad network access, resource pooling, rapid elasticity, measured service, and so forth. A cloud computing model may be used to expose various service models, such as, for example, Hardware as a Service (“HaaS”), Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth.

A regular expression can include various characters and symbols, including the ones shown in Table 1 below.

TABLE 1
a. A character to be matched. (e.g., “a”, “b”)
b. Assertions about the current position in the payload. An assertion
can be a special constraint (e.g., the beginning of a word or the
beginning of a line). An assertion can also be a token in which case
the parenthesis are supplemented with a matching direction and
optional negation of the match.
c. Repetition of a token with a lower_bound >= 0 and an
upper_bound >= lower_bound. Repetition can be lazy, eager, or
possessive. The upper bound can be set to a special value which
represents infinity. (e.g., “a”{0, 8}, “a”{1, inf}, “a”{5, 5}).
d. Sequence of tokens to be matched. (e.g., “a” “b” “c”).
e. Alternation of Tokens (match A or B). (e.g., (“a” or “b” or “c”)).
f. Capture group. Capture group is a token in which a matched
payload string is stored for further matching once the token
has been matched. (e.g., Capture is a token in parenthesis).
g. Backreference is a reference to a capture group.
(e.g., (“a” or “b”)\\1).

As noted earlier, the DFA has a finite set of states and a transition arc for each payload byte to another (or possibly the same) state. What makes a DFA fast (and big) is that it is in only one state at a time (as opposed to a non-deterministic finite automaton). Each payload byte is consumed and the appropriate arc is followed. Since there are 256 possible values for a payload byte, each state can have 256 arcs to another state. This aspect of the DFAs alone grows the graph quickly. Frequently several states in a DFA graph have remarkably similar transitions to one another. Consistent with the examples described herein, instead of storing each of these transitions separately for each state, a combined state is created, and then a transition to this combined state is made without consuming a byte. Such a transition is referred to as a fall-through transition. Such a fall-through transition has the disadvantage of adding an extra transition, which slows the matching using the DFA. However, it can also dramatically reduce the size of the DFA graph. Advantageously, the reduced size of the DFA graph allows for caching of a larger percentage of the states associated with the DFA graph. Moreover, those states that correspond to the fall-through slots are likely to be hot and hence in the cache. This means that the extra transition that is occurring because of the implementation of the fall-through slots is likely to have a low additional cost. Furthermore, a smaller DFA graph has a greater likelihood of fitting entirely in the cache, and thus significantly speeding up the search.

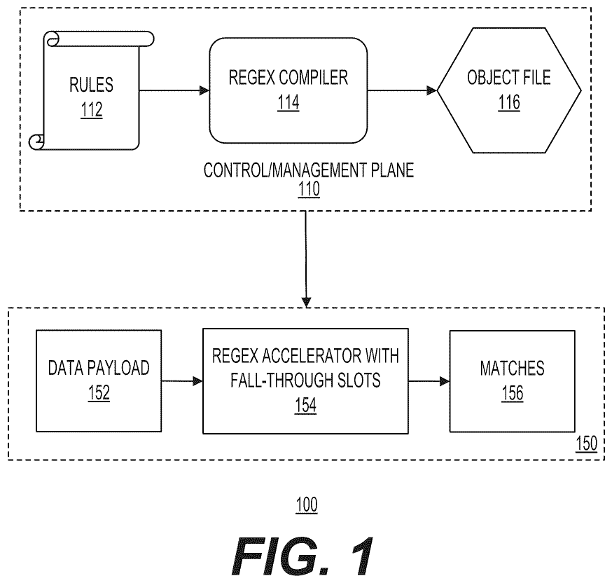

FIG. 1 is a block diagram of a system environment 100 for implementing fall-through slots for deterministic finite automatons (DFAs) in a regular expression accelerator in accordance with one example. Regex system environment 100 shows a control/management plane 110 coupled to a device/data plane 150. Regex system environment 100 includes a regex compiler 114, which takes rules 112 as input and generates an object file 116 as an output. Object file 116 is in a form (e.g., a binary form) that can be processed by regex accelerator with fall-through slots (RAFTS) 154. RAFTS 154 is configured to process NFA graphs, DFA graphs, and other software artifacts generated by regex compiler 114. RAFTS 154 can receive data payload 152 and match input strings or other types of payload against the regular expression patterns to generate matches 156. Although FIG. 1 shows system environment 100 as having certain components that are arranged in a certain manner, system environment 100 may include additional or fewer components that are arranged differently.

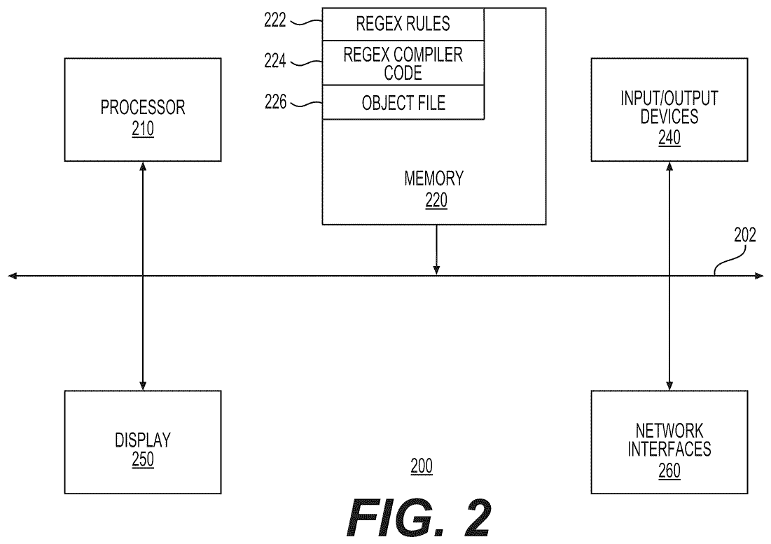

FIG. 2 is a block diagram of a system 200 for implementing fall-through slots in accordance with one example. System 200 includes a processor 210, a memory 220, input/output devices 240, display 250, and network interfaces 260 interconnected via bus system 202. Memory 220 includes regex rules 222, regex compiler code 224, and object file 226. Regex rules 222 may include the various regex pattern files and other rules for processing input strings. Regex compiler code 224 may include code corresponding to the regex compiler 130 of FIG. 1. Object file 226 may include the output generated by the execution of the regex compiler code 224 by processor 210. Although FIG. 2 shows a certain number of components of system 200 arranged in a certain way, additional or fewer components arranged differently may also be used. In addition, although memory 220 shows certain blocks of code, the functionality provided by this code may be combined or distributed. In addition, the various blocks of code may be stored in non-transitory computer-readable media, such as non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory, such as, DRAM, SRAM, a cache, or other such media. In addition, as described herein the term code is not limited to “code” expressed in a particular encoding or expression via a particular syntax. As an example, code may include graphs or other forms of encodings.

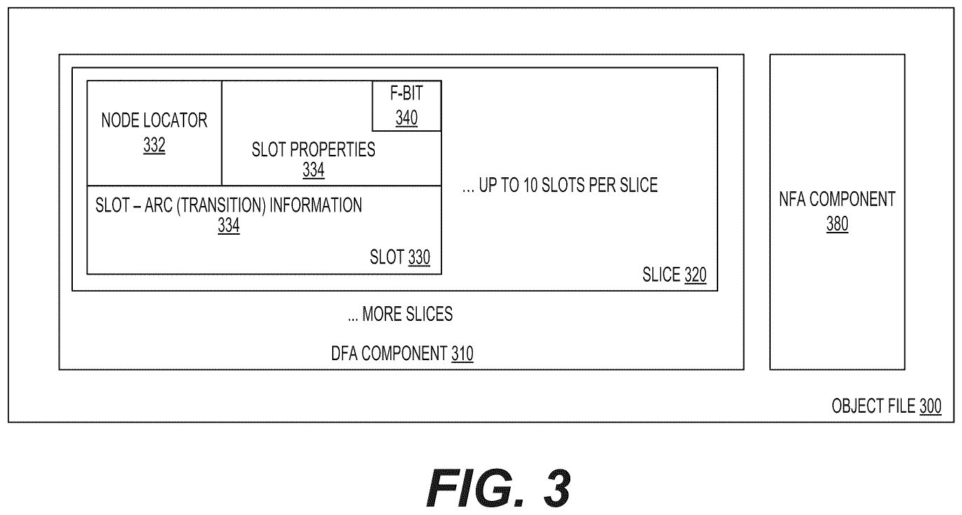

FIG. 3 shows an example layout of an object file 300 for implementing fall-through slots for DFAs in a regex accelerator (e.g., RAFTS 154 of FIG. 1) in accordance with one example. In this example, object file 300 (similar to object file 116 of FIG. 1 and object file 226 of FIG. 2) is generated upon execution of regex compiler code 224 by processor 210. Object file 300 includes information necessary for the regex accelerator to process DFA graphs and NFA graphs. In this example layout, the DFA component 310 includes the information for the DFA graphs and the NFA component 380 includes the information for the NFA graphs. DFA component 310 includes slices of memory (e.g., slice 320). Each slice of memory includes a certain number of memory blocks allocated to the slice. Each slice includes a certain number of slots (e.g., slot 330). In one example, each slice can include up to ten slots.

With continued reference to FIG. 3, each slot corresponds to a transition arc from one node to another. In this example, slot 330 includes a node locator 332, slot properties 334 (including an F-bit 340 indicating whether the slot is a through-slot), and slot-arc (transition) information 338. Node locator 332 includes information on which node to transition in case the fall-through bit is set. In cases where the fall-through bit is not set, the transition occurs to another node after the consumption of a portion (e.g., a byte) of the payload. The F-bit 340 is set when it has logical high value. Slot properties 334 includes information concerning the nature of the slot, e.g., whether the slot corresponds to a match node or another type of node. Slot properties 334 includes sufficient information for the regex accelerator to determine which type of node it is, which type of payload a corresponding node accepts, whether a portion of the payload will be consumed as part of the transition from one node to another, and whether the slot corresponds to a fall-through slot. Slot-arc (transition) information 338 can also include information concerning how many times can a transition be followed when the F-bit 340 is set. Such information can allow the regex accelerator to avoid denial of service (DOS) attacks. This is because the transitions occurring when the fall-through bit is set may include transitions from one node to itself, creating the potential for looping that could cause a denial of service (DOS) attack. Although FIG. 3 shows a certain layout of object file 300 with certain aspects included in the object file 300, it can have a different layout with fewer or more aspects. As an example, depending on the need for the regex accelerator to receive additional information concerning the slot, such information can be included as part of the slot properties 334 or other aspects of the object file 300.

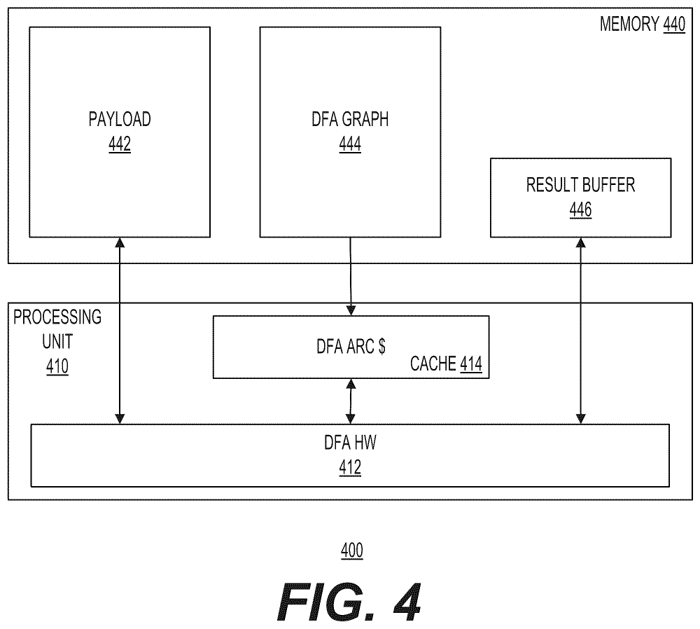

FIG. 4 shows a logical block diagram of a regex accelerator 400 for implementing fall-through slots for DFAs in accordance with one example. Regex accelerator 400 can be used to implement the fall-through slots functionality associated with RAFTS 154 of FIG. 1 and other regex accelerators described herein. In this example, regex accelerator 400 includes a processing unit 410 coupled to a memory 440. Processing unit 410 can be implemented as any processor that can interact with memory 440 to enable the functionality associated with a DFA instance with fall-through slots. In this example, processing unit 410 incudes DFA hardware (DFA HW) 412 and a cache 414 with the portion of the DFA graph (e.g., DFA ARC $ shown in cache 414) loaded into cache 414 for faster processing. As explained earlier, for certain workloads the use of fall-through slots allows the compiler to produce a compact graph representations for the DFA pre-filters. This reduced size of the DFA graph allows one to load more of the DFA graph into the cache (e.g., cache 414 of FIG. 4), which improves the hit-rate in the on-chip memory cache (e.g., cache 414) and ultimately improves the performance of the regular expression accelerator.

With continued reference to FIG. 4, memory 440 can be implemented as a high-speed bandwidth memory (HBM), which is a 3D stack of memory chips. Alternatively, memory 440 can be implemented as a single-chip SDRAM or another form of volatile memory. In any case, memory 440 is closely coupled with processing unit 410 to allow for faster processing of the DFA graph by the DFA instance. In this example, memory 440 includes a payload 442, a DFA graph 444, and a result buffer 446. Table 2 below shows the operations performed as part of processing a payload for matching by the regex accelerator 400 of FIG. 4.

TABLE 2
1. The regex accelerator software (SW) loads the object file (e.g.,
object file 300 of FIG. 3) resulting from the compilation of regex rules
(e.g., regex patterns) into the memory (e.g., memory 440 of FIG. 4).
2. The SW allocates memory for a result buffer (e.g., result buffer
446 of FIG. 4).
3. The SW receives a data payload (e.g., payload 442 of FIG. 4) from
a network service, a storage service, or another software service.
4. The SW sends a search request to the DFA hardware (e.g., DFA
HW 412 of FIG. 4) with pointers to the payload, the DFA graph,
and the result buffer.
5. The DFA HW reads through the payload bytes while following the
state transitions in the graph.
6. If the DFA HW arrives at a “match” state as indicated by the
graph, it writes (or appends) the position in the payload at which the
match occurred to the result buffer.
7. The DFA HW notifies the SW when the DFA HW has finished
reading the payload (e.g., payload 442 of FIG. 4).

Although Table 2 describes a specific set of operations associated with regex accelerator 400, the regex accelerator 400 may execute additional or fewer operations during the processing of the payload and the DFA graph. In addition, although FIG. 4 shows regex accelerator 400 having a certain number of components that are arranged in a certain manner, the regex accelerator can include additional or fewer components that are arranged differently.

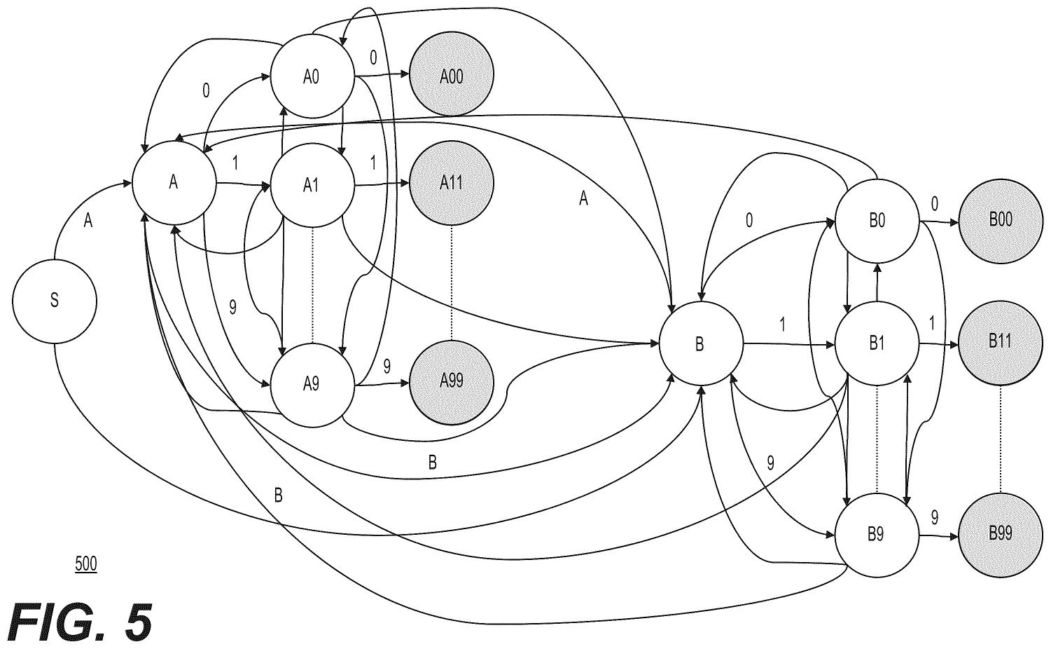

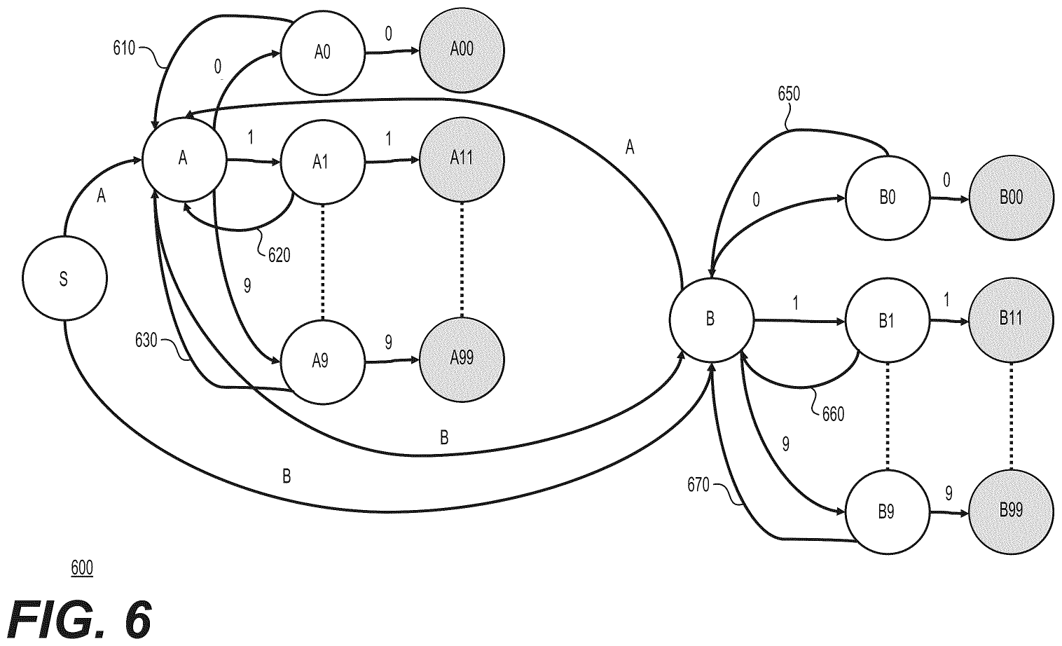

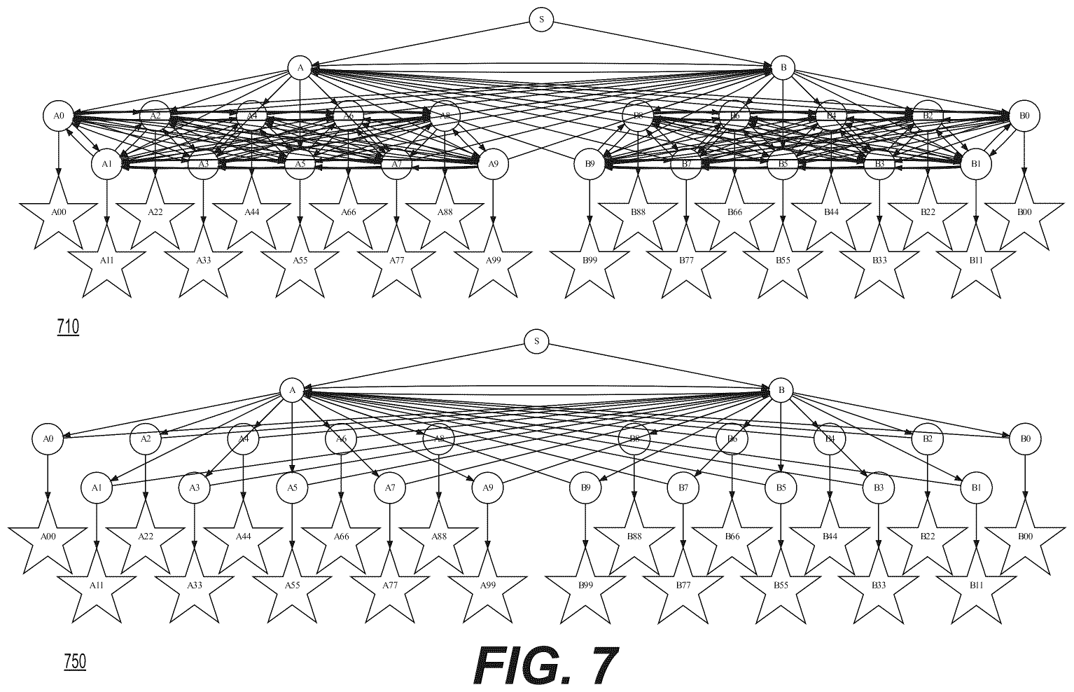

To further explain the use of fall-through slots as part of the DFAs, FIGS. 5 and 6 show the difference between two simplified version of the DFA graphs-one with the benefit of the fall-through slots and the other without the benefit of the fall-through slots. FIG. 7 shows comparison of the full versions of the DFA graphs (710 and 750 of FIG. 7) corresponding to the simplified versions of the DFA graphs shown in FIGS. 5 and 6, respectively.

Referring now to FIG. 5, which shows a simplified version of a DFA graph 500 without fall-through slots, the patterns shown in table 3 below are processed to generate the DFA graph 500.

TABLE 3

Pattern 1: /A[\hat{ }B]*(00|11|22|33|44|55|66|77|88|99)/
Pattern 2: /B[\hat{ }A]*(00|11|22|33|44|55|66|77|88|99)/

A payload matches Pattern 1 shown in table 3 above if and only if it is of the form A . . . DD where the payload does not contain B and the two digits (Ds) are the same digit. On the other hand, a payload matches Pattern 2 shown in table 3 above if and only if it is of the form B . . . DD where the payload does not contain A and the two digits (Ds) are the same digit. As an example, the payload “A000B11” will have three matches: (1) the second 0 in the payload completes a match of Pattern 1, (2) the third 0 in the payload completes a match of Pattern 1, and (3) the second 1 in the payload completes a match of Pattern 2. The DFA graph 500 includes a start state (labeled S) during which neither A nor B has been seen yet. As shown in the simplified version of the DFA graph 500 has 43 states, including the start state, of which 20 states are matching states. Table 4 below describes these 43 states:

TABLE 4

| State | Description | Comments |
|---|---|---|
| 1. S | Start state. | There is one such state. Neither |
| | | A nor B has been seen yet. |
| 2. A only | A seen but no digit yet. | There is one such state. |
| 3. Ad | A seen with a single | There are ten such states. |
| | digit (for d = 0 . . . 9). | |
| 4. Add | A seen with the same | There are ten such states. |
| | digit repeated twice | These are all match states for |
| | (for d = 0 . . . 9). | Pattern 1. |
| 5. B only | B seen but no digit yet. | There is one such state. |
| 6. Bd | B seen with a single | There are ten such states. |
| | digit (for d = 0 . . . 9). | |
| 7. Bdd | B seen with the same | There are ten such states. |
| | digit repeated twice | These are all match states for |
| | (for d = 0 . . . 9). | Pattern 2. |

As evident from table 4 above, the states numbered 3, 4, 6, and 7 in the table above have the following transitions shown in table 5 below:

TABLE 5
Transitions

1. If the payload digit is the same, it goes to state Add (or to state Bdd).
2. If the payload digit is different, it goes to state Ad (or to state Bd).
3. If the payload byte is A or B, it goes to the appropriate state.
4. Any other digit goes to state A or state B only.

As shown in graph 500 of FIG. 5, there are twelve transitions for the 40 states, resulting in a total of 480 such transitions.

Referring now to FIG. 6, a simplified version of the DFA graph 600 with the benefit of the fall-through slots is shown. Fall-through slots are implemented in a manner described above with respect to FIGS. 1-4. As an example, the regex compiler is configured to, instead of storing each of these transitions separately for each state, create a combined state, when possible. Then a transition to this combined state is made without consuming a byte. Such a transition is referred to as a fall-through transition. As an example, the simplified version of the DFA graph 600, resulting from the use of fall-through slots, shows significantly fewer transitions than the DFA graph 500 of FIG. 5. In this example, the regex compiler recognizes that unless the digit is the same as the previous one, all the outgoing arcs are the same as the A only state or the B only state. Having recognized this, the regex compiler is configured to output as part of the object file additional information (e.g., the F-bit described earlier). Specifically, out of the A state, the transitions are: (1) B goes to the B state only, (2) digit d (d=0 . . . 9) goes to the Ad state, and (3) anything else goes to the A state only. This results in twelve different transitions. In addition, out of the Ad (d=0 . . . 9) state, the transitions are: (1) B goes to the B state only (in this case, only one byte of the payload (256 bytes) is accepted), (2) digits d goes to the Add state (in this case, only one byte of the payload is accepted), (3) any other digit d′ (0 . . . d−1, d+1 . . . 9) goes to the Ad′ state (in this case, nine bytes of the payload are accepted and each of the nine arcs point to a different node of the DFA graph), and (4) anything else goes to the A state only (since the prior cases accepts total of 11 bytes, this case accepts the remaining 245 bytes of the payload).

As part of this example, all of these transitions can be compacted to two transitions: (1) digit d goes to the Add state (e.g., arc 620 and arc 630 of FIG. 6), and (2) anything else falls through to A state only (represented by newly added arc 610 in DFA graph 600). Similarly, all of the transitions related to the B state can be compacted to two transitions: (1) digit d goes to the Bdd state (e.g., arc 660 and arc 670 of FIG. 6), and (2) anything else falls through to B state only (represented by newly added arc 650 in DFA graph 600).

FIG. 7 shows the comparison between the full version 710 of a DFA graph (corresponding to DFA graph 500 of FIG. 5) and the full version 750 another DFA graph (corresponding to DFA graph 600 of FIG. 6). In each of these versions, the states identified inside stars correspond to the match states and the other the states identified inside circles correspond to the other states of the respective DFA graph. Since the reduction from 12 transitions to two transitions is occurring for 40 states, as part of the full version 750 of the DFA graph shown in FIG. 7, 400 transitions have been eliminated that were part of the full version 710 of the DFA graph. The original DFA graph (e.g., full version 710 of the DFA graph) had a total of 507 (3+42*12) transitions. Advantageously, this represents a 78% reduction in the number of the transitions in the DFA graph. As noted earlier, the reduced size of the DFA graph allows for caching of a larger percentage of the states associated with the DFA graph. Moreover, those states that correspond to the fall-through slots are likely to be hot and hence in the cache. This means that any extra transitions that are occurring because of the implementation of the fall-through slots are likely to have a low additional cost. Furthermore, a smaller DFA graph has a greater likelihood of fitting entirely in the cache, and thus significantly speeding up the search.

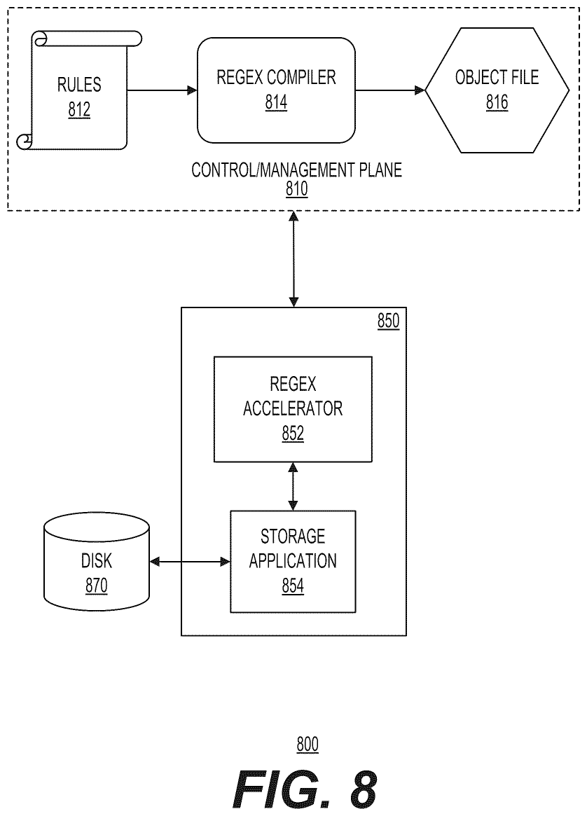

FIG. 8 is a block diagram of a storage appliance use case 800 for a regex accelerator with fall-through slots. Storage appliance use case 800 shows a control/management plane 810 coupled to a storage appliance 850, which is further coupled to a storage disk 870. The control/management plane 810 includes a regex compiler 814 (similar to regex compiler 114 of FIG. 1), which takes rules 812 as input and generates an object file 816 as an output. Object file 816 is in a form (e.g., a binary form) that can be processed by regex accelerator 852. Regex accelerator 852 (similar to regex accelerator with fall-through slots 154 of FIG. 1), is configured to process NFA graphs, DFA graphs, and other software artifacts generated by regex compiler 814. Regex accelerator 852 is coupled to a storage application 854, which in turn can store or retrieve data from storage disk 870.

With continued reference to FIG. 8, regex accelerator 852 is configured to search through string data for virus signatures or other forms of malware. In addition, regex accelerator 852 is configured to detect any personally identifiable information (PII). Moreover, regex accelerator 852 can also be configured to apply DFA-filters on numeric columns in a database. As explained earlier with respect to FIGS. 1-7, regex accelerator 852 is configured to use fall-through slots. Slot properties included as part of the slot information has sufficient information for the regex accelerator 852 to determine which type of node it is processing, which type of payload a corresponding node accepts, whether a portion of the payload will be consumed as part of the transition from one node to another, and whether the slot corresponds to a fall-through slot. In addition, slot information (e.g., slot-arc (transition) information 338 of FIG. 3) also includes information concerning how many times can a transition be followed (e.g., as described earlier with respect to FIG. 3 and the F-bit 340). Such information can allow the regex accelerator 852 to avoid denial of service (DOS) attacks on any services offered by storage appliance 850. This is because absent such information, the transitions occurring when the fall-through bit is set may include transitions from one node to itself, creating the potential for looping that could cause a denial of service (DOS) attack.

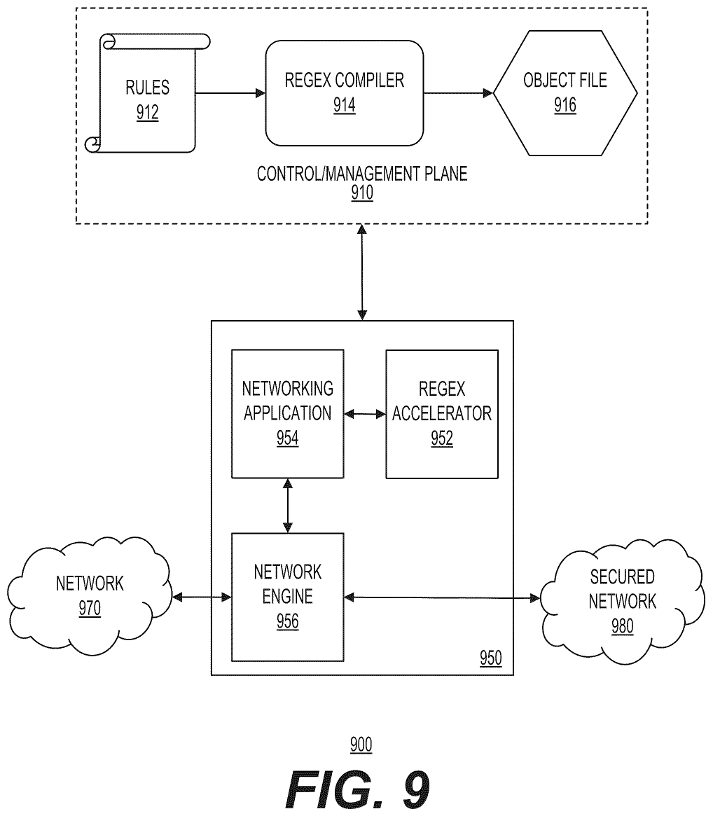

FIG. 9 is a block diagram of a network appliance use case 900 for a regex accelerator with fall-through slots. The network appliance use case 900 shows a control/management plane 910 coupled to a networking appliance 950, which is further coupled to a network 970 and a secured network 980. The control/management plane 910 includes a regex compiler 914 (similar to regex compiler 114 of FIG. 1), which takes rules 912 as input and generates an object file 916 as an output. Object file 916 is in a form (e.g., a binary form) that can be processed by regex accelerator 952. Regex accelerator 952 (similar to regex accelerator with fall-through slots 154 of FIG. 1), is configured to process NFA graphs, DFA graphs, and other software artifacts generated by regex compiler 914. Regex accelerator 952 is coupled to a networking application 954, which in turn is coupled to a network engine 956. Networking appliance 950 is coupled to a network 970 and a secured network 980. Secured network 980 is more secure because unlike network 970, the networking traffic traveling to and from secured network 980 is subjected to real-time inspection.

With continued reference to FIG. 9, regex accelerator 952 can be configured to search through real time networking traffic to perform deep packet (payload) inspection based on rules (e.g., rules 912). In addition, regex accelerator 952 can be configured as part of intrusion detection systems (IDS) and intrusion prevention systems (IPS). As explained earlier with respect to FIGS. 1-7, regex accelerator 952 is configured to use fall-through slots. Slot properties included as part of the slot information has sufficient information for the regex accelerator 952 to determine which type of node it is processing, which type of payload a corresponding node accepts, whether a portion of the payload will be consumed as part of the transition from one node to another, and whether the slot corresponds to a fall-through slot. In addition, slot information (e.g., slot-arc (transition) information 338 of FIG. 3) also includes information concerning how many times can a transition be followed (e.g., as described earlier with respect to FIG. 3 and the F-bit 340). Such information can allow the regex accelerator 952 to avoid denial of service (DOS) attacks on any services offered by networking appliance 950. This is because absent such information, the transitions occurring when the fall-through bit is set may include transitions from one node to itself, creating the potential for looping that could cause a denial of service (DOS) attack.

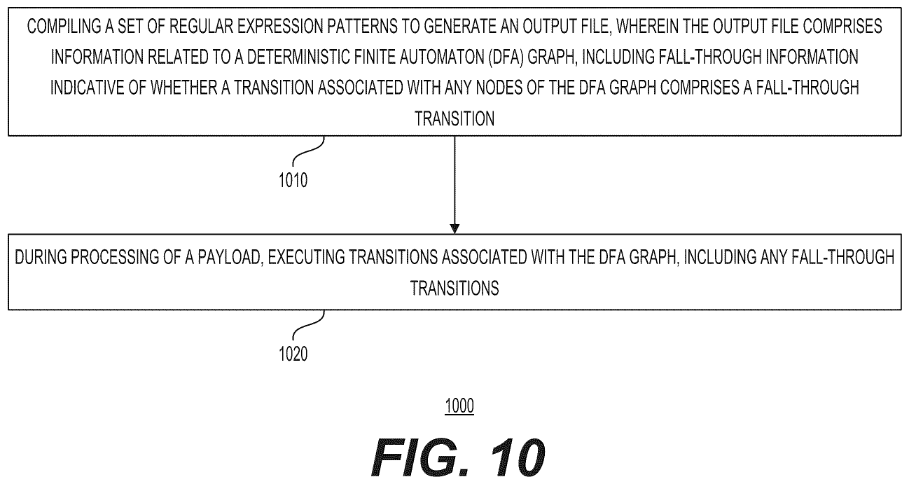

FIG. 10 is a flow chart 1000 of a method for implementing fall-through slots for deterministic finite automatons (DFAs) in a regular expression accelerator in accordance with one example. Step 1010 includes compiling a set of regular expression patterns to generate an output file, wherein the output file comprises information related to a deterministic finite automaton (DFA) graph, including fall-through information indicative of whether a transition associated with any nodes of the DFA graph comprises a fall-through transition. In one example, this step included compiling the set of regular expression patterns included using the regex compiler 114 to generate the object file as the output file. As an example, when regex compiler code 222 is executed by processor 210 of FIG. 2, the object file 226 of FIG. is output. Moreover, FIG. 3 shows an example object file 300 with an F-bit 340 included as part of the slot information. The information included as part of F-bit 340 of FIG. 3 could be encoded using other means, as well.

Step 1020 includes during processing of a payload, executing transitions associated with the DFA graph, including any fall-through transitions. In one example, this step can be performed by the regex accelerator 400 of FIG. 4 as part of processing a payload (e.g., payload 442 of FIG. 4). As another example, either regex accelerator 852 or regex accelerator 952 may perform this step as part of providing a storage service or a network service. As explained earlier with respect to FIGS. 5-7, the fall-through transition comprises traversing along an edge of the DFA graph without consuming any portion of the payload being processed. Moreover, the use of the fall-through slots significantly reduces the size of the DFA graph (e.g., as shown in FIG. 7). Advantageously the reduced size of the DFA graph allows for caching of a larger percentage of the states associated with the DFA graph. Moreover, those states that correspond to the fall-through slots are likely to be hot and hence in the cache. This means that any extra transitions that are occurring because of the implementation of the fall-through slots are likely to have a low additional cost. Furthermore, a smaller DFA graph has a greater likelihood of fitting entirely in the cache, and thus significantly speeding up the search.

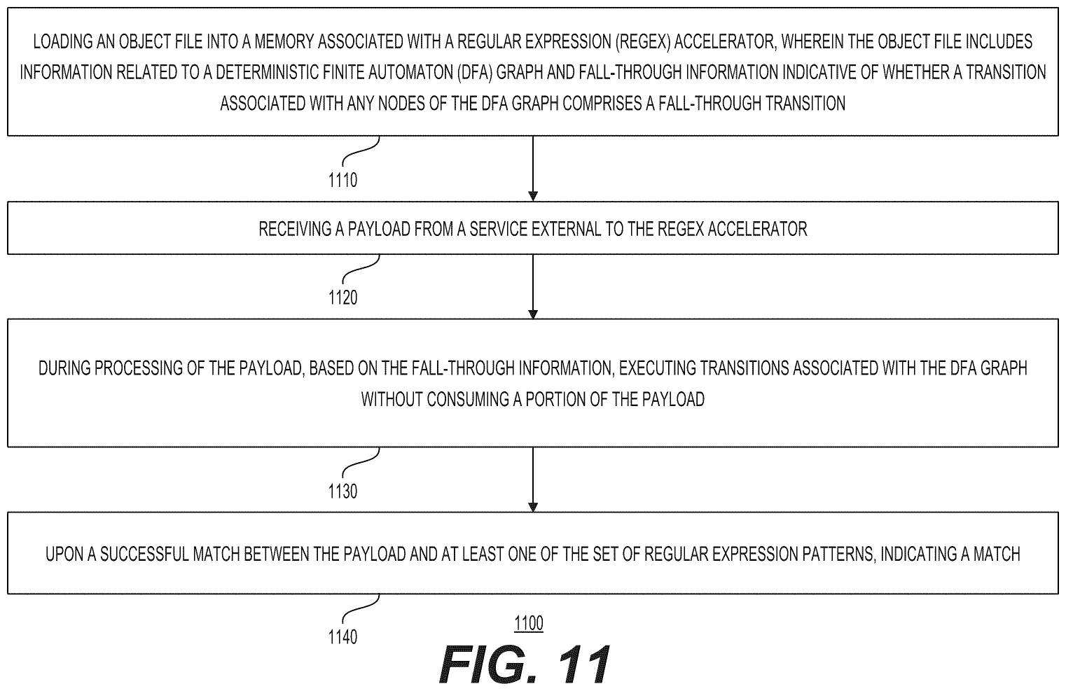

FIG. 11 is a flow chart 1100 of a method for implementing fall-through slots for deterministic finite automatons (DFAs) in a regular expression accelerator in accordance with one example. Step 1110 includes loading an object file into a memory associated with a regular expression (regex) accelerator, wherein the object file includes information related to a deterministic finite automaton (DFA) graph and fall-through information indicative of whether a transition associated with any nodes of the DFA graph comprises a fall-through transition. In one example, this step included compiling the set of regular expression patterns included using the regex compiler 114 to generate the object file as the output file. As an example, when regex compiler code 222 is executed by processor 210 of FIG. 2, the object file 226 of FIG. 2 is output. Moreover, FIG. 3 shows an example object file 300 with an F-bit 340 included as part of the slot information. The information included as part of F-bit 340 of FIG. 3 could be encoded using other means, as well.

Step 1120 includes receiving a payload from a service external to the regex accelerator. Step 1130 includes during processing of the payload, based on the fall-through information, executing transitions associated with the DFA graph without consuming a portion of the payload. In one example, these steps can be performed by the regex accelerator 400 of FIG. 4 as part of processing a payload (e.g., payload 442 of FIG. 4). As another example, either regex accelerator 852 or regex accelerator 952 may perform this step as part of providing a storage service or a network service. As explained earlier with respect to FIGS. 5-7, the fall-through transition comprises traversing along an edge of the DFA graph without consuming any portion of the payload being processed. Moreover, the use of the fall-through slots significantly reduces the size of the DFA graph (e.g., as shown in FIG. 7). Advantageously the reduced size of the DFA graph allows for caching of a larger percentage of the states associated with the DFA graph. Moreover, those states that correspond to the fall-through slots are likely to be hot and hence in the cache. This means that any extra transitions that are occurring because of the implementation of the fall-through slots are likely to have a low additional cost. Furthermore, a smaller DFA graph has a greater likelihood of fitting entirely in the cache, and thus significantly speeding up the search.

Step 1140 includes upon a successful match between the payload and at least one of the set of regular expression patterns, indicating a match. In one example, this step can be performed by the regex accelerator 400 of FIG. 4 as part of processing a payload (e.g., payload 442 of FIG. 4). As another example, either regex accelerator 852 or regex accelerator 952 may perform this step as part of providing a storage service or a network service. Although FIG. 11 describes several steps performed in a certain order, additional or fewer steps may be performed in a different order.

In conclusion, the present disclosure relates to a method comprising compiling a set of regular expression patterns to generate an output file, wherein the output file comprises information related to a deterministic finite automaton (DFA) graph, including fall-through information indicative of whether a transition associated with any nodes of the DFA graph comprises a fall-through transition. The method may further, include during processing of a payload, executing transitions associated with the DFA graph, including any fall-through transitions.

As part of this method, executing transitions associated with the DFA graph may comprise traversing along an edge of the DFA graph, and as part of traversing the edge along the DFA graph, consuming a portion of a payload being processed. The fall-through transition comprises traversing along an edge of the DFA graph without consuming any portion of the payload being processed.

The information indicative of whether a transition associated with any nodes of the DFA graph may comprise a fall-through transition comprises a fall-through bit. As a result of this method, a DFA graph with fall-through transitions has fewer transitions than a DFA graph without fall-through transitions.

The method may further include caching a larger amount of information for the DFA graph with fall-through transitions relative to the DFA graph without fall-through transitions. As part of this method, during compiling, fall-through transitions may be added to the DFA graph while reducing a total number of transitions associated with the DFA graph.

In another example, the present disclosure relates to a method comprising loading an object file into a memory associated with a regular expression (regex) accelerator, wherein the object file includes information related to a deterministic finite automaton (DFA) graph and fall-through information indicative of whether a transition associated with any nodes of the DFA graph comprises a fall-through transition.

The method may further include the regex accelerator receiving a payload for processing. The method may further include, during processing of the payload, based on the fall-through information, executing transitions associated with the DFA graph without consuming a portion of the payload.

The information indicative of whether a transition associated with any nodes of the DFA graph may comprise a fall-through transition comprises a fall-through bit. As a result of this method, a DFA graph with fall-through transitions has fewer transitions than a DFA graph without fall-through transitions.

The method may further include comprising caching a larger amount of information for the DFA graph with fall-through transitions relative to the DFA graph without fall-through transitions. As part of this method, during compiling, fall-through transitions may be added to the DFA graph while reducing a total number of transitions associated with the DFA graph. The method may further include compiling a set of regular expression patterns to generate the output file.

In yet another example, the present disclosure relates to a method comprising loading an object file into a memory associated with a regular expression (regex) accelerator, wherein the object file includes information related to a deterministic finite automaton (DFA) graph and fall-through information indicative of whether a transition associated with any nodes of the DFA graph comprises a fall-through transition. The method may further include receiving a payload from a service external to the regex accelerator.

The method may further include during processing of the payload, based on the fall-through information, executing transitions associated with the DFA graph without consuming a portion of the payload. The method may further include, upon a successful match between the payload and at least one of the set of regular expression patterns, indicating a match.

The information indicative of whether a transition associated with any nodes of the DFA graph may comprise a fall-through transition comprises a fall-through bit. As a result of this method, a DFA graph with fall-through transitions has fewer transitions than a DFA graph without fall-through transitions. The method may further include caching a larger amount of information for the DFA graph with fall-through transitions relative to the DFA graph without fall-through transitions.

The regex accelerator may comprise multiple DFA instances and multiple non-deterministic finite automaton (NFA) instances. During compiling, fall-through transitions may be added to the DFA graph while reducing a total number of transitions associated with the DFA graph. The method may further comprise: (1) allocating a portion of the memory for a result buffer, and (2) for each transition into a match state associated with the DFA graph, appending a position of the payload at which the match occurred to the result buffer.

It is to be understood that the methods, modules, and components depicted herein are merely exemplary. Alternatively, or in addition, the functionally described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), or Complex Programmable Logic Devices (CPLDs). In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory, such as, DRAM, SRAM, a cache, or other such media. Non-transitory media is distinct from, but can be used in conjunction with transmission media. Transmission media is used for transferring data and/or instruction to or from a machine. Exemplary transmission media, include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A method comprising:
compiling a set of regular expression patterns to generate an output file, wherein the output file comprises information related to a deterministic finite automaton (DFA) graph, including fall-through information indicative of whether a transition associated with any nodes of the DFA graph comprises a fall-through transition; and
during processing of a payload, executing transitions associated with the DFA graph, including any fall-through transitions.

2. The method of claim 1, wherein executing transitions associated with the DFA graph comprises traversing along an edge of the DFA graph, and as part of traversing the edge along the DFA graph, consuming a portion of a payload being processed.

3. The method of claim 2, wherein the fall-through transition comprises traversing along an edge of the DFA graph without consuming any portion of the payload being processed.

4. The method of claim 1, wherein the information indicative of whether a transition associated with any nodes of the DFA graph comprises a fall-through transition comprises a fall-through bit.

5. The method of claim 1, wherein a DFA graph with fall-through transitions has fewer transitions than a DFA graph without fall-through transitions.

6. The method of claim 5, further comprising caching a larger amount of information for the DFA graph with fall-through transitions relative to the DFA graph without fall-through transitions.

7. The method of claim 1, wherein during compiling, fall-through transitions are added to the DFA graph while reducing a total number of transitions associated with the DFA graph.

8. A method comprising:
loading an object file into a memory associated with a regular expression (regex) accelerator, wherein the object file includes information related to a deterministic finite automaton (DFA) graph and fall-through information indicative of whether a transition associated with any nodes of the DFA graph comprises a fall-through transition;
the regex accelerator receiving a payload for processing; and
during processing of the payload, based on the fall-through information, executing transitions associated with the DFA graph without consuming a portion of the payload.

9. The method of claim 8, wherein the information indicative of whether a transition associated with any nodes of the DFA graph comprises a fall-through transition comprises a fall-through bit.

10. The method of claim 8, wherein a DFA graph with fall-through transitions has fewer transitions than a DFA graph without fall-through transitions.

11. The method of claim 10, further comprising caching a larger amount of information for the DFA graph with fall-through transitions relative to the DFA graph without fall-through transitions.

12. The method of claim 8, wherein during compiling, fall-through transitions are added to the DFA graph while reducing a total number of transitions associated with the DFA graph.

13. The method of claim 8, further comprising, compiling a set of regular expression patterns to generate the output file.

14. A method comprising:
loading an object file into a memory associated with a regular expression (regex) accelerator, wherein the object file includes information related to a deterministic finite automaton (DFA) graph and fall-through information indicative of whether a transition associated with any nodes of the DFA graph comprises a fall-through transition;
receiving a payload from a service external to the regex accelerator;
during processing of the payload, based on the fall-through information, executing transitions associated with the DFA graph without consuming a portion of the payload; and
upon a successful match between the payload and at least one of the set of regular expression patterns, indicating a match.

15. The method of claim 14, wherein the information indicative of whether a transition associated with any nodes of the DFA graph comprises a fall-through transition comprises a fall-through bit.

16. The method of claim 14, wherein a DFA graph with fall-through transitions has fewer transitions than a DFA graph without fall-through transitions.

17. The method of claim 16, further comprising caching a larger amount of information for the DFA graph with fall-through transitions relative to the DFA graph without fall-through transitions.

18. The method of claim 14, wherein the regex accelerator comprises multiple DFA instances and multiple non-deterministic finite automaton (NFA) instances.

19. The method of claim 18, wherein during compiling, fall-through transitions are added to the DFA graph while reducing a total number of transitions associated with the DFA graph.

20. The method of claim 14, further comprising: (1) allocating a portion of the memory for a result buffer, and (2) for each transition into a match state associated with the DFA graph, appending a position of the payload at which the match occurred to the result buffer.
